(19) United States
(12) Patent Application Publication
(10) Pub. No.: US 2026/0103966 A1
(43) Pub. Date: Apr. 16, 2026

(54) SYSTEMS AND METHODS FOR WATERFLOOD OPERATIONS

(71) Applicant: SCHLUMBERGER TECHNOLOGY CORPORATION, Sugar Land, TX (US)

(72) Inventors: Sanjoy Kumar KHATANIAR, Abingdon (GB); Shripad BINIWALE, Abu Dhabi (AE); Mohamed AHMED, Abu Dhabi (AE)

(21) Appl. No.: 19/113,037

(22) PCT Filed: Sep. 19, 2023
(86) PCT No.: PCT/US2023/033135

§ 371 Date: Mar. 19, 2025

Related U.S. Application Data
(60) Provisional application No. 63/376,138, filed on Sep. 19, 2022.

(51) Int. Cl. E21B 43/20; G05B 13/02; G05B 13/04

(52) U.S. Cl. CPC E21B 43/20; G05B 13/0265; G05B 13/048; E21B 2200/22

(57) ABSTRACT

A method including receiving injector-producer pair parameters for injectors and producers in a target underground region. The injectors and the producers may be characterized as injector-producer pairs. The method also includes converting the injector-producer pair parameters into coefficients stored in a data structure. The coefficients represent estimates of connection strengths between the injectors and producers. The method also includes generating, from the coefficients, a performance indicator that represents an operational relationship between a corresponding injector and a corresponding producer in an injector-producer pair. The method also includes transmitting the performance indicator to a pattern flood management application.

### RELATED APPLICATIONS

This application claims priority to U.S. Provisional Patent Application 63/376,138, filed Sep. 19, 2022, the entirety of which is hereby incorporated by reference.

### BACKGROUND

Waterflooding may be used during the exploration and production of oil or gas. Enhanced oil recovery techniques, such as waterflooding, may involve injecting water, gas, or other fluid into a first well, referred to as an injector. The resulting subterranean pressure forces subterranean oil out of a second well remote from the first well. The second well is referred to as a producer.

Waterflood performance and long-term recovery in mature fields (i.e., fields in which producers start to produce less oil) can be enhanced by continuous surveillance and well control. For example, numerical simulation-based studies of a target underground region may be used to develop strategic plans that advise oilfield operations personnel on well and facility management.

However, when using such detailed models, unscheduled field and well events leave very little time to react in a timely and appropriate manner. As a result, loss of oil and gas production performance may occur as a result of unscheduled events. Repeated occurrence of such unscheduled events can reduce long-term oil and gas production performance.

Furthermore, strategic plans are a challenge to follow precisely, and thus changes in a planned schedule of events may occur occasionally. Such changes can influence a waterflooding management plan, and thus there may be cause to modify the waterflooding management plan when such a change occurs. However, the complexity of numerical simulation-based studies of the target underground region may prohibit modification of a waterflooding management plan in a timely manner.

### SUMMARY

One or more embodiments provide for a method. The method includes receiving injector-producer pair parameters for injectors and producers in a target underground region. The injectors and the producers may be characterized as injector-producer pairs. The method also includes converting the injector-producer pair parameters into coefficients stored in a data structure. The coefficients represent estimates of connection strengths between the injectors and producers. The method also includes generating, from the coefficients, a performance indicator that represents an operational relationship between a corresponding injector and a corresponding producer in an injector-producer pair. The method also includes transmitting the performance indicator to a pattern flood management application.

Other aspects of the one or more embodiments will be apparent from the following description and the appended claims.

### BRIEF DESCRIPTION OF DRAWINGS

FIG. 1 illustrates an example of a system that includes various management components to manage various aspects of a geologic environment, in accordance with one or more embodiments.

FIG. 2.1 and FIG. 2.2 show a computing system, in accordance with one or more embodiments.

FIG. 3 shows a method, in accordance with one or more embodiments.

FIG. 4.1, FIG. 4.2, FIG. 4.3, FIG. 4.4, and FIG. 4.5 show an example of improving the computational speed of pattern flood management, in accordance with one or more embodiments.

FIG. 5 illustrates a schematic view of a computing system, in accordance with one or more embodiments.

Like elements in the various figures are denoted by like reference numerals for consistency.

### DETAILED DESCRIPTION

In general, embodiments of the disclosure include a digital system for reservoir surveillance and production operations engineers. The digital system supports operational decision making by rapidly evaluating multiple action alternatives (“what-if” scenarios). The alternatives may enhance production operating set points for oil and gas wells by adjusting the set points according to those alternatives predicted to be most likely to enhance production. Thus, one or more embodiments described herein may be used to evaluate options and take action quickly in response to changing conditions at an oil and gas field.

It is possible to enhance the selection of an oil field's set points by performing simulations of projected oil field activities using detailed physical models of a target underground region. Studies using numerical reservoir simulation methodology may be used to develop strategic plans that advise oilfield operations personnel on longer term reservoir management, which may be a year or more.

However, due to the computing intensive nature of such detailed models, unscheduled field and well events make it difficult to react in a timely manner when performing simulations using such detailed models. Recurrence of such unscheduled events can negatively impact long-term performance of the oil field, resulting in less total production and longer production times. Recurrence of such unscheduled events is anticipated in real production operations, because it is impractical to follow a strategic plan precisely in real operation conditions. In other words, an original strategic plan cannot be followed precisely because field conditions deviate from assumptions made during the development of such plans.

Therefore, a technical problem exists when performing simulations of oil and gas operations in a target underground region. The technical problem is how to increase the speed of simulation execution to a degree where real time optimization scenarios can be performed at an operating oil and gas field without terminating or reducing production. Real time, for some embodiments, refers to a set of simulations is performed quickly enough such that a new, quantitative field management plan may be developed and implemented while ongoing production remains uninterrupted, or interrupted for a minimum time. In some embodiments, the set of simulations desirably should be performed in hours to a few days in order to accommodate changing a strategic field plan without inhibiting ongoing production.

However, current simulation techniques using detailed models may take weeks or even months to perform enough optimization scenarios. Enough optimization scenarios, for some embodiments, refers to a sufficient number of scenarios are modeled that a quantitative assessment of the optimization may be performed within a selected margin of error. Generating enough optimization scenarios using detailed models may take weeks to months to perform due to the extreme complexity of the simulation algorithms and the vast data input into the algorithms. In other words, generating a desirable number of “what-if” scenarios using available detailed models takes far too long for detailed models to be useful tools for performing oil and gas production simulations in real time.

It is possible to increase the speed of simulations by decreasing the data used to perform the simulations. However, it is not desirable to reduce the amount of data in the detailed models, or to change the simulation algorithms upon which the detailed models operate, to reduce the time used to generate enough scenarios. To reduce data used or to simplify the algorithms may reduce the accuracy of the simulations produced using the detailed models. Reducing the accuracy of the simulations defeats the goal of performing the optimization scenarios to maximize oil and gas production efficiency and quantity.

Therefore, oil and gas field operators and engineers currently do not have the ability to perform desirably accurate oil and gas field simulations at a real time speed. One or more embodiments described herein solve this technical problem by way of one or more technical solutions. One or more technical solutions described herein may be used to generate field simulations results within the time frame of hours to a few days that satisfies the desire for real time results, while retaining a desirable degree of accuracy of the simulation results. Stated differently, one or more technical solutions described herein increase the speed and efficiency of a computing system to generate an oil and gas field simulation result, while retaining a desired accuracy of the simulation result.

In brief summary, the technical solution lies in bypassing the use of detailed simulation models when performing a real time simulation. In particular, one or more machine learning models take the data in the models as input and generate, as output, performance indicators. The performance indicators then may be passed to a pattern flood management application, which in turn generates an oil and gas field simulation result. The data pre-processing step of generating the performance indicators is less computationally intensive than performing full detailed simulations using the models. Additionally, the performance indicators represent less data than the output of a simulation result that otherwise might be passed to the pattern flood management application. Thus, the pattern flood management application also executes more quickly.

In this manner, one or more embodiments improve the computational efficiency of generating simulation results and corresponding pattern flood management plans. A predicted performance of a simulation-based pattern flood management plan has been compared to a real performance observed after implementing the simulation-based plan. It has been observed that the one or more technical solutions described herein retain an acceptable degree of accuracy. Thus, one or more technical solutions described herein solve the technical problem described above by permitting generation of sufficiently accurate oil and gas field simulation results in real time.

Reference will now be made in detail to embodiments, examples of which are illustrated in the accompanying drawings and figures. In the following detailed description, numerous specific details are set forth in order to provide a thorough understanding of the technology. However, it will be apparent to one of ordinary skill in the art that the technology may be practiced without these specific details. In other instances, well-known methods, procedures, components, circuits, and networks have not been described in detail so as not to unnecessarily obscure aspects of the embodiments. Attention is now directed to processing procedures, methods, techniques, and workflows that are in accordance with some embodiments. Some operations in the processing procedures, methods, techniques, and workflows disclosed herein may be combined and/or the order of some operations may be changed.

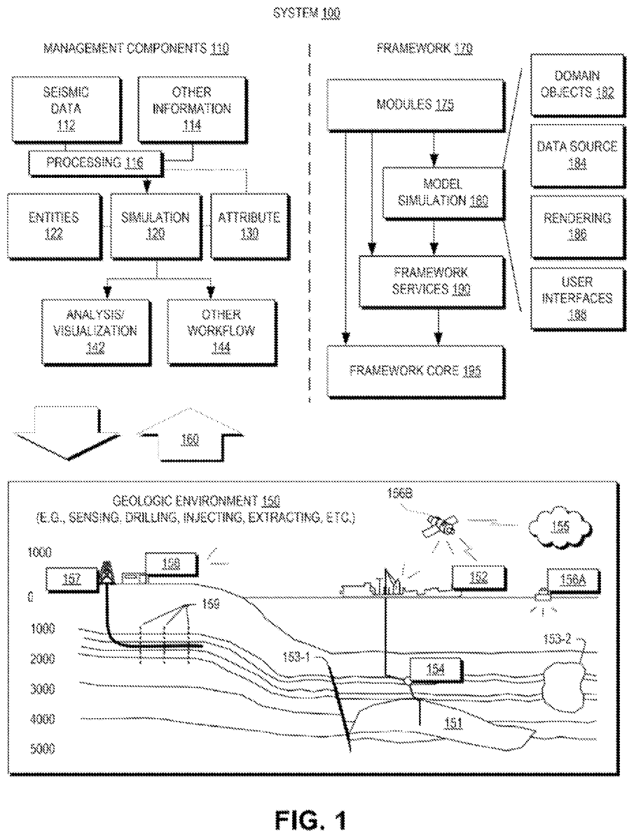

FIG. 1 illustrates an example of a system 100 that includes various management components 110 to manage various aspects of a geologic environment 150 (e.g., an environment that includes a sedimentary basin, a reservoir 151, one or more faults 153-1, one or more geo-bodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the seismic data component 112 and the additional information component 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data component 112 and other information components 114). An entity may be characterized by one or more properties. For example, a geometrical pillar grid entity of an earth model may be characterized by a porosity property. Such properties may represent one or more measurements (e.g., acquired data), calculations, etc. determined from the entity.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, the simulation component may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages. NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and, optionally, other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources which may be at the same or different physical locations and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geo-body 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156A or 156B may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of work steps. A work step may operate on data, for example, to create new data, to update existing data, etc. As an example, a work step may operate on one or more inputs and create one or more results, for example, based on one or more algorithms. As an example, a system may include a workflow editor for creation, editing, executing, etc. of a workflow. In such an example, the workflow editor may provide for selection of one or more pre-defined work steps, one or more customized work steps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more work steps that access a module such as a plug-in (e.g., external executable code, etc.).

Embodiments of the disclosure include a decision support system for waterflood operations that evaluates the impact of scheduled and unscheduled events in the short term and suggests corrective actions for performance enhancement. For example, an analyzer evaluates water injection actions and production balancing actions to achieve certain goals, such as injection utilization, voidage replacement, and sweep efficiency. The goals can be applied to the whole field or individual injection patterns. The analyzer is based on the pattern flood management method implemented in INTERSECT® reservoir simulator and has been adapted to work with a machine learning-based hybrid model, in at least some embodiments.

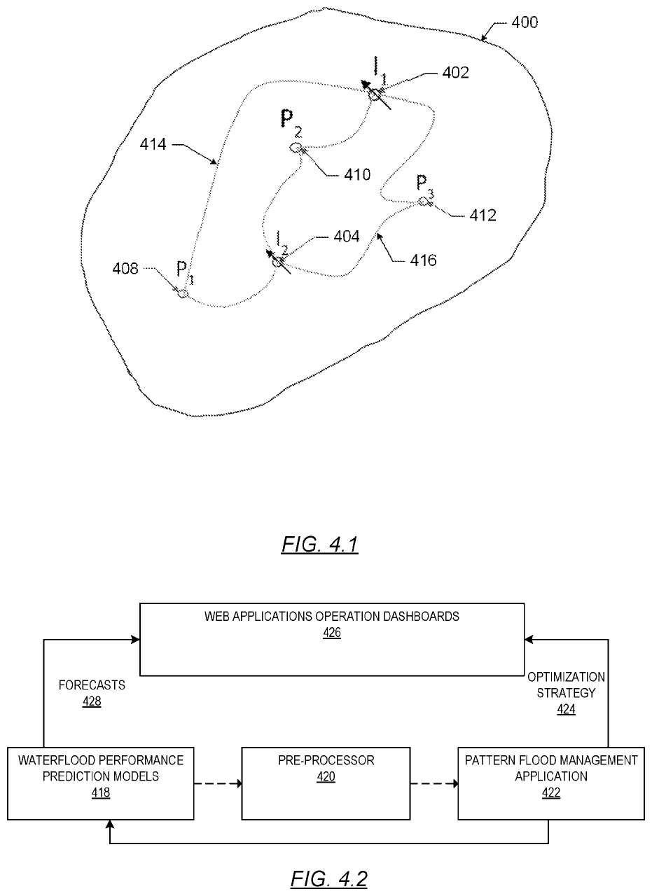

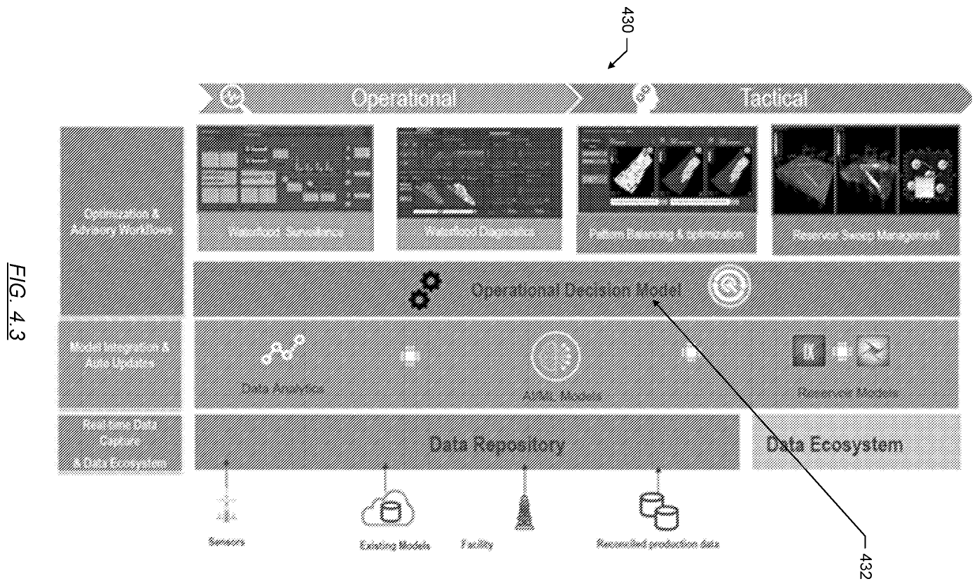

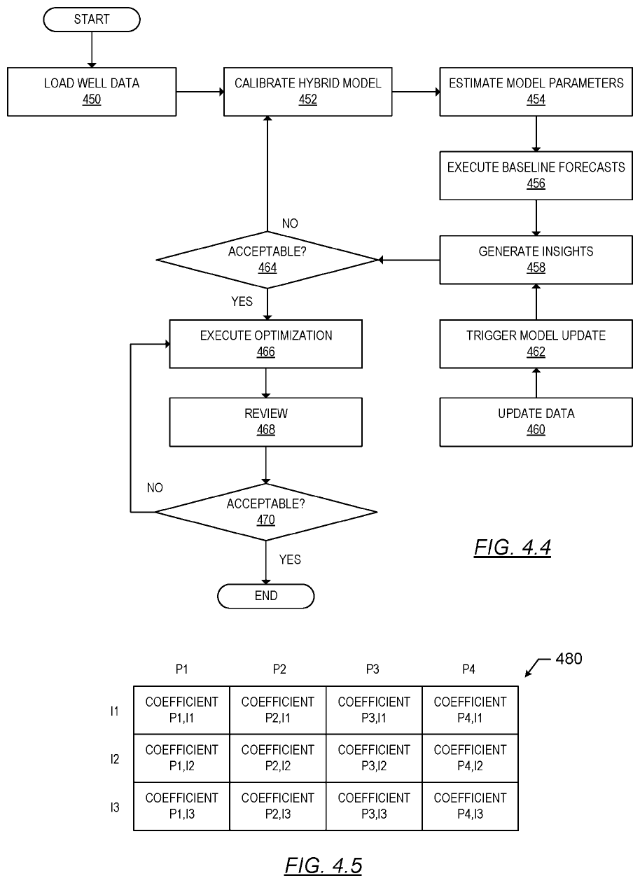

The analyzer (e.g., the pre-processor shown in FIG. 4.2) is initialized with current injector-producer relationship parameters computed by a data-driven waterflood performance prediction model (e.g., the waterflood performance prediction models of FIG. 4.2). The initialization may be achieved computationally quickly using a machine learning-assisted hybrid signal processing and multi-variate regression model of a waterflood. The same model may also compute the objective function used in the analysis process.

Embodiments may also include an information processor configured to post-process information from data and model-driven waterflood performance prediction models for use during analysis. Thus, the analysis method can take the input from any source, including reservoir simulation models. The ML-assisted hybrid waterflood model is connected to a production database source for updating on demand. In at least some embodiments, the method may be implemented in a cloud computing environment, and dashboards may be constructed as web applications for use by reservoir surveillance engineers.

Analyzing and enhancing waterflood operations using reservoir simulation models (e.g., physics-based models) can be computationally cumbersome and thus not feasible in real time. The reasons for the computational intensity of such models are based on several factors. The factors include the fact that the models may not be up to date and calibrated, as updating takes time and effort from modeling experts who generally do not work in on-field operations. The factors also include a lack of understanding of reservoir simulation models by reservoir surveillance engineers. Thus, the models may not operate efficiently in on-field operations. The factors also include the fact that mature fields may not have a full field reservoir simulation model available.

Waterflood operation analysis and enhancement may call for short-term forecasting capabilities, and the data-driven machine learning-assisted hybrid models of one or more embodiments can deliver this result accurately without reservoir simulation knowledge to operate the more complex models. One or more embodiments use a combination of signal processing techniques to pre-condition the injector-producer relationship matrix and then uses machine learning regression techniques to train, test, and validate the model using observed production data. Thus, reservoir surveillance engineers can use these models quickly. Furthermore, as the data used to build these models is composed of injector-producer pairs and well locations, multiple waterflood scenarios can be rapidly modeled and considered. The time used to build a model and calibrate the model is relatively small as compared to a full reservoir simulation.

Data-driven classes of waterflood performance prediction models may use methods such as machine learning models, physics-based machine learning models, and semi-analytical or analytical models, but may not be integrated with the pattern flood management (PFM) analysis and enhancement method existing inside some numerical reservoir simulators. Some implementation of the present disclosure may combine a PFM method with the hybrid machine learning model to increase efficiency, reaching levels of computational speed that allow interactive evaluation of hundreds of alternative solutions. This combination of technologies (the pre-processing and PFM technologies) may operate alongside numerical reservoir models also using PFM. Thus, one or more embodiments provide a combination of both data-driven and model-driven methods for operations and tactical and strategic waterflood performance analysis and enhancement.

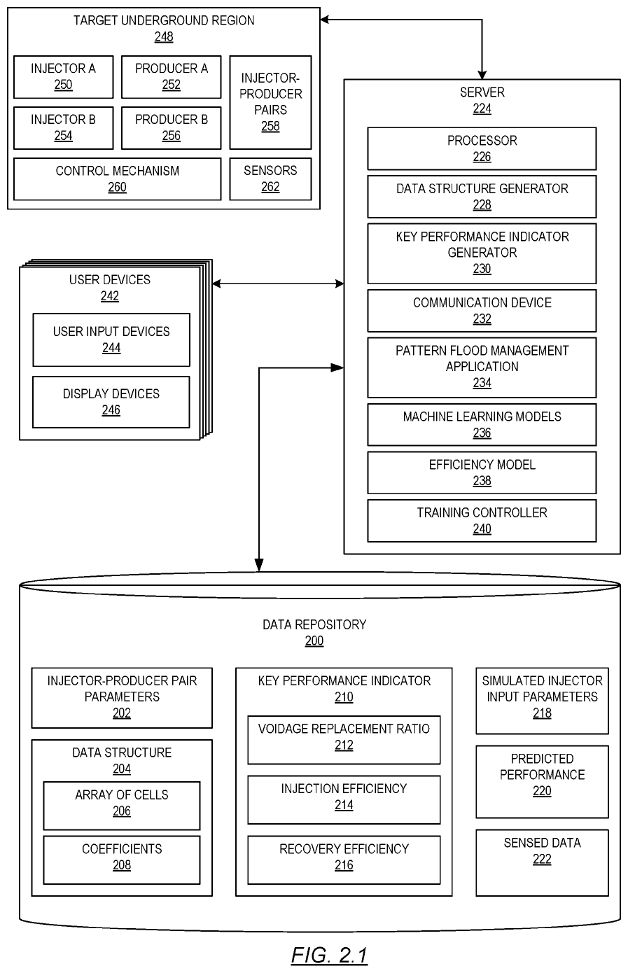

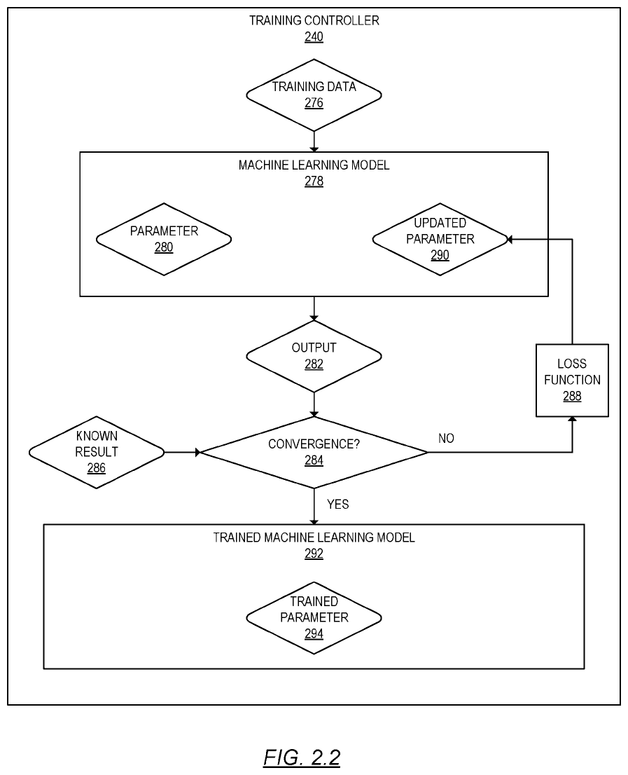

FIG. 2.1 and FIG. 2.2 show a computing system, in accordance with one or more embodiments. In particular, FIG. 2.1 shows a computing system, and FIG. 2.2 shows the details of a training controller shown in FIG. 2.1. The training controller may be executed to train the machine learning models described herein.

The system shown in FIG. 2.1 includes a data repository (200). The data repository (200) is a type of storage unit and/or device (e.g., a file system, database, data structure, or any other storage mechanism) for storing data. The data repository (200) may include multiple different, potentially heterogeneous, storage units and/or devices.

The data repository (200) stores one or more injector-producer pair parameters (202). The injector-producer pair parameters (202) are features that describe one or more physical properties of an injector-producer pair.

An injector, as used herein, is a well in the Earth that is used to inject a fluid (e.g., water, or other gas or fluid) into the earth. Injection of the fluid increases a pressure in a portion of a target underground region (248). In turn, a producer, as used herein, is a well in the Earth that is used to receive oil and gas (and waste products, such as water) from the target underground region (248). Thus, an injector is used to increase pressure in the target underground region (248), which in turn pushes oil, gas, and other fluids out of a producer.

An oil and gas production field often includes multiple injectors and multiple producers, such as shown in FIG. 4.1. The target underground region (248) may include large reservoirs which are in direct fluid communication with the injectors and the producers. Thus, through the reservoirs, the injectors and the producers may be in indirect fluid communication with each other.

For simulation purposes, injectors and producers may be treated as being in pairs (e.g., injector-producer pairs). Changing the injection fluid parameters (pressure, flow rate, salinity, etc.) of an injector can have an influence over at least some of the multiple producers. Changing the injection fluid parameters for multiple injectors concurrently may result in complex changes in production at the various producers.

Thus, the injector-producer pair parameters (202) numerically represent the properties of, and complex interaction of, injectors and producers. Examples of the injector-producer pair parameters (202) may include (but are not limited to) flow capacity, storage capacity, and characteristics of the delay in response to pressure pulse signal at an injector. The latter is strongly influenced by the pore volume in the pair element. The pore volume, in turn, is impacted by reservoir characteristics of porosity and thickness, and the pore volume of the pair element. Flow capacity is influenced by the average permeability-thickness of the fluids ejected at a producer. These, and other, measured physical characteristics are associated for each pair of injectors and producers, thereby forming the injector-producer pair parameters (202).

The data repository (200) also may store a data structure (204). The data structure (204) is a data organization, management, and storage format for use with a computing system. The data structure (204) may store a collection of data values, the relationships among them, and the functions or operations that can be applied to the data contained in the data structure (204).

The data structure (204) may be an array of cells (206). The array of cells (206) represents pairs of injectors and producers, and each of the array of cells stores one of the coefficients (208). The data structure (204) may be a relational database in the form of a table, the entries of which are the array of cells (206). However, the array of cells (206) may be stored as nodes in a graph database, with relationships among the array of cells (206) being recorded as edges of the graph database. Accordingly, the data structure (204) is not limited to a table, and may take the form of other types of data structures.

The data structure (204) is used to store one or more coefficients (208). The coefficients (208) are numbers (e.g., values stored in the array of cells (206)) that represent estimates of physical connection strengths between injectors and producers of the injector-producer pairs. In other words, the coefficients (208) represent how strongly a change in fluid injector parameters at an injector influences production at the multiple producers. Generation of the coefficients (208) is described with respect to FIG. 2.1.

The data repository (200) also stores a performance indicator (210). The performance indicator (210) is a number that represents an operational relationship between an injector-producer pair. The performance indicator (210) is generated using the coefficients (208) in the data structure (204), as described with respect to FIG. 2.1.

While the singular term is used for the performance indicator (210), one or more embodiments contemplate the use of multiple performance indicators. Thus, as used herein, reference to the performance indicator (210) automatically contemplates use of multiple performance indicators, each of which represents different operational aspects or estimates of an injector-producer pair.

An example of a performance indicator is a voidage replacement ratio (212) of an injector-producer pair. The voidage replacement ratio (212) is a ratio between the volume of injected fluid at an injector and the volume of produced fluid at a corresponding producer of the injector-producer pair, as measured at reservoir conditions over an increment of time. Thus, the voidage replacement ratio (212) is a measure of the rate of change in reservoir energy. An operator may attempt to maintain a voidage replacement ratio close to 1 during the operational life of a production field.

Another example of a performance indicator may be an injection efficiency (214) of an injector. The injection efficiency (214) represents the amount of oil or gas produced at the producer relative to the rate of fluid injection at the injector, or relative to the energy consumed to inject the fluid.

Another example of a performance indicator is a recovery efficiency (216) of an injector-producer pair. The recovery efficiency (216) is the fraction of oil or gas that is estimated to exist in the target underground region (248) that can be economically recovered when using a given process. Economically recovered, for some embodiments, refers to the money that can be earned from produced oil and gas exceeds the money expended to produce the produced oil and gas.

Other types of performance indicators may be used. Thus, the embodiments described herein are not necessarily limited to the performance indicators described above. Furthermore, more or fewer performance indicators may be used other than the example performance indicators mentioned above.

The data repository (200) also may store one or more simulated injector input parameters (218). The simulated injector input parameters (218) are features, for which values are assigned, that are input to a pattern flood management application (234) (defined below). Note that the simulated injector input parameters (218) is used in the plural sense, though one or more embodiments may use one simulated injector input parameter.

The simulated injector input parameters (218) may take a variety of forms. For example, the simulated injector input parameters (218) may include assigned or predicted values for fluid injection into each of the injectors (e.g., fluid type, fluid rate, fluid amount, fluid properties, etc.). Thus, the simulated injector input parameters (218) represent a “what-if” scenario, e.g., a prediction is being sought regarding how the producers will produce if the simulated injector input parameters (218) are set for the injectors in view of the performance indicator (210).

In another example, the simulated injector input parameters (218) may be changes to producer bottom hole pressure and injection rate as input and control of the injector. The changes to the producer bottom hole pressure may be controlled by changing the rate of fluid production (e.g., with a valve), while changes to the injection rate may be controlled by changing the rate of fluid injection (e.g., with another valve). Other simulated injector input parameters (218) also are contemplated.

The data repository (200) also stores a predicted performance (220). The predicted performance (220) is an output of the pattern flood management application (234). More specifically, the predicted performance (220) represents one or more values of various measures of performance for one or more of the producers. For example, the predicted performance (220) may include the amount of oil and gas (or waste fluid) produced, the rate of production, the relative amounts of production among multiple products (e.g., the relative percentage of oil, gas, waste fluid), etc. Thus, the predicted performance (220) may be considered the result of a “what-if” scenario.

The data repository (200) also may include sensed data (222). The sensed data (222) is data sensed by one or more of sensors (262) used to sense one or more physical properties of the target underground region (248). Examples of the sensed data (222) may include subsurface density, rock type, voids, porosity, distribution of reservoirs, locations of lineaments (such as faults), etc. The sensed data (222) may be available in one or more detailed models, such as the detailed subsurface models mentioned above, or may be sensed and then processed as described below.

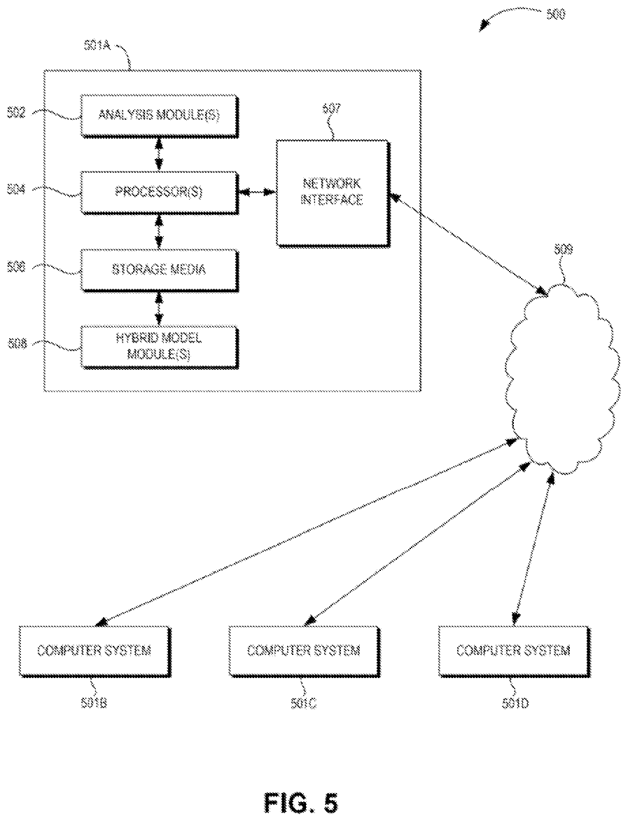

The system shown in FIG. 2.1 also may include a server (224). The server (224) may be one or more computing systems such as, for example, the computing system shown in FIG. 5.

The server (224) may include a processor (226). The processor (226) is one or more hardware processors or virtual processors which can execute computer readable program code. The processor (226) may be multiple processors executing in a distributed computing environment.

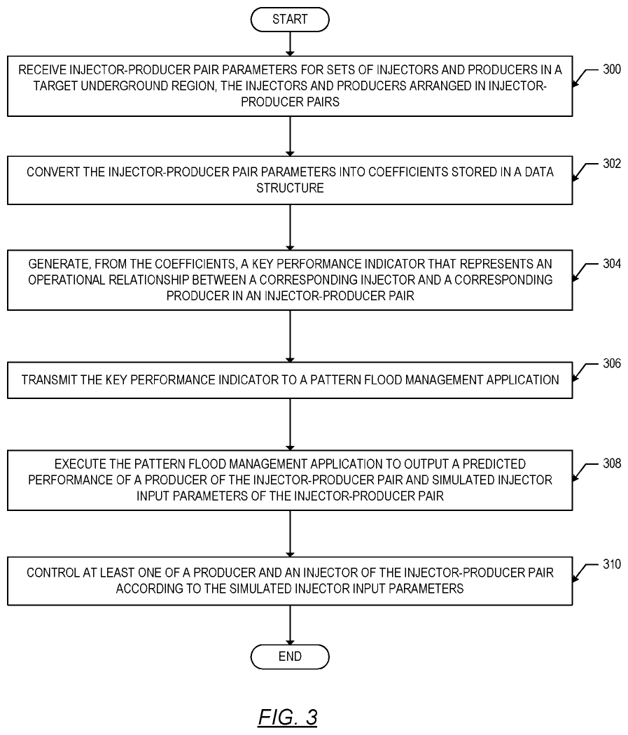

The server (224) may include a data structure generator (228). The data structure generator (228) is software or application specific hardware which, when executed by the processor (226), generates the data structure (204). The data structure generator (228) also, when executed, may determine the coefficients (208) and arrange the coefficients (208) in the array of cells (206) of the data structure (204). Operation of the data structure generator (228) is described with respect to step 302 of FIG. 3.

The server (224) may include a performance indicator generator (230). The performance indicator generator (230) is software or application specific hardware which, when executed by the processor (226), generates or determines the performance indicator (210). Operation of the performance indicator generator (230) is described with respect to step 304 of FIG. 3.

The server (224) may include a communication device (232). The communication device (232) is hardware or software which permits the server (224) to communicate with one or more user devices (242), the data repository (200), or the sensors (262) in the target underground region (248). Examples of the communication device (232) may include software such as application programming interfaces (APIs) or hardware such as wireless communication ports, USB ports, ethernet cards, etc.

The server (224) also may include a pattern flood management application (234). The pattern flood management application (234) is software or application specific hardware which, when executed, takes as input the performance indicator (210) and the simulated injector input parameters (218) and generates, as output, the predicted performance (220). An example of the pattern flood management application (234) is described with respect to FIG. 4.2. Operation of the pattern flood management application (234) is described respect to step 308 of FIG. 3.

The server (224) also may include one or more machine learning models (236). The machine learning models (236) are machine learning algorithms which, when executed, find hidden patterns in data. More specifically, the machine learning models (236) may take, as input, the sensed data (222) and generate, as output, the injector-producer pair parameters (202). The input of the machine learning models (236) may include data extracted from a physics-based model (described below).

Examples of the machine learning models (236) include streamline, finite difference-based numerical reservoir simulation models, capacitance-resistance models with machine learning regression, correlation-type statistical models with vector auto-regression, and random forest classification models that are used to identify the injector-producer pairs. Operation of the machine learning models (236) is described with respect to step 300 of FIG. 3.

For some embodiments, machine learning algorithm refers to the term machine learning model. Machine learning algorithm, for some embodiments, is used in some contexts in order to distinguish machine learning (e.g., artificial intelligence) from a model which describes an underground region in some way that is not based on machine learning. Additionally, a computer-implemented algorithm may be software (whether machine learning or rules-based) or may be application specific hardware.

For example, the one or more embodiments may refer to a physics-based model. A physics-based model is a detailed model of a target underground region that may be used to predict how different physical aspects of a system may react to changing physical conditions. A physics-based model, for some embodiments, is a detailed model, as described above, and thus may be computationally expensive to execute.

For example, a physics-based machine learning model may be executed on an input, and then the model outputs a predicted flow of fluids in a target underground region. The input may include sensed data, physical relationships between different areas of a target underground region, known principles of fluid mechanics, and other forms of input to predict the flow of fluid in a system. Different types of physics-based models may predict different properties of the target underground region. However, as used herein for some embodiments, a physics-based model may be impractical for use in real time pattern flood management predictions.

The server (224) also may include an efficiency model (238). The efficiency model (238) is a machine learning algorithm which takes, as input, the injector-producer pair parameters (202), and generates, as output, the coefficients (208) in the data structure (204). The efficiency model (238) may be, for example, an autoregression machine learning model. Operation of the efficiency model (238) is described with respect to step 302 of FIG. 3.

The server (224) also may include a training controller (240). The training controller (240) is software or application specific hardware which, when executed, trains any of the machine learning models (236) or the efficiency model (238). The details and operation of the training controller (240) are described with respect FIG. 2.2.

The system shown in FIG. 2.1 may include one or more user devices (242). The user devices (242) may be computing systems, such as desktop computers, laptop computers, tablets, smart phones, etc. The user devices (242) may be, for example, personal computing devices available on site at a oil and gas production field. The user devices (242) tend to have fewer computing resources than the server (224). However, the one or more embodiments described herein could be executed using the user devices (242), rather than the server (224), because the processing efficiency increase achieved by the techniques described herein permit pattern flood management prediction on individual user devices.

The user devices (242) may include one or more user input devices (244). The user input devices (244) may be keyboards, mice, speakers, haptic devices, touchscreens, graphical user interfaces, etc. for inputting information into the user devices (242). The user devices (242) also may include one or more display devices (246) for displaying information on the user devices (242). The display devices (246) may include monitors, computer screens, speakers, haptic devices, etc.

The system shown in FIG. 2.1 may refer to the target underground region (248). The target underground region (248) is a pre-defined subsurface volume of the Earth. The target underground region (248) in some embodiments is the production field where oil and gas are being produced, or some subsection of such a field.

The target underground region (248) may include a number of injectors, such as the injector A (250) and the injector B (254). The injectors are wells drilled into the Earth in the target underground region (248) and used to inject fluid (water, gas, etc.) into the Earth.

Similarly, the target underground region (248) may include a number of producers, such as the producer A (252) and the producer B (256). The producers are wells drilled into the Earth in the target underground region (248) and used to collect oil, gas, and possibly waste fluid after the fluids have been injected into the Earth via the injectors.

Note that the difference between injectors and producers is functional, not structural. For example, the same wellbore in the Earth could be assigned to be injector in one pattern flood management plan, but be assigned to be a producer in another pattern flood management plan. Physically, different equipment might be installed, or existing equipment altered, to permit the change of the use of a well from producer to injector, and vice versa. The well could also be adjusted in some way, but both injectors and producers are holes drilled into the Earth.

The injectors and producers may be arranged in injector-producer pairs (258). The injector-producer pairs (258) are sets of one injector paired with one or more producers, or one or more injectors paired with a producer. Each of the injector-producer pairs (258) in the target underground region (248) may have a different relationship. For example, a first injector may have a strong fluid connection with a first producer, but the first injector may have a weak fluid connection with a second producer. Each of the injector-producer pairs (258) may have a number of physical properties, which are the injector-producer pair parameters (202) described above.

In an embodiment, a control mechanism (260) may be present in or above the target underground region (248). The control mechanism (260) is hardware or software, or a combination thereof, used to control oil and gas exploration and production equipment. For example the equipment may be a pump which injects fluid into an injector. In this case, the control mechanism (260) may be software connected to a solenoid that controls the pressure or flow rate at which the pump pumps fluid. In another example, the equipment may be a valve which controls the direction of flow of a fluid in either an injector or a producer. In this case, the control mechanism (260) may be software connected to a valve that controls the flow of the fluid in the injector or the producer. The control mechanism (260) may take the form of many different devices for controlling the operation of equipment used in oil and gas exploration and production.

The target underground region (248) may include one or more sensors (262) disposed in or on the target underground region (248). The target underground region (248) may take measurements of the target underground region (248), such as seismic measurements, depth measurements, pressure measurements, salinity measurements, and many other physical parameters. The data collected by the sensors (262) may form the basis for the values assigned to the injector-producer pair parameters (202).

Attention is turned to FIG. 2.2, which shows the details of the training controller (240). The training controller (240) is a training algorithm, implemented as software or application specific hardware, that may be used to train one or more the machine learning models described with respect to FIG. 2.1, including the machine learning models (236), the efficiency model (238), and possibly the performance indicator generator (230).

In general, machine learning models are trained prior to being deployed. The process of training a model, briefly, involves iteratively testing a model against test data for which the final result is known, comparing the test results against the known result, and using the comparison to adjust the model. The process is repeated until the results do not improve more than some predetermined amount, or until some other termination condition occurs. After training, the final adjusted model (e.g., the trained machine learning model (292)) is applied to new data in order to make predictions.

In more detail, training starts with training data (276). The training data (276) is data for which the final result is known with certainty. For example, if the machine learning task is to identify whether two names refer to the same entity, then the training data (276) may be name pairs for which it is already known whether any given name pair refers to the same entity.

The training data (276) is provided as input to the machine learning model (278). The machine learning model (278), as described before, is an algorithm. However, the output of the algorithm may be changed by changing one or more parameters of the algorithm, such as the parameter (280) of the machine learning model (278). The parameter (280) may be one or more weights, the application of a sigmoid function, a hyperparameter, or possibly many different variations that may be used to adjust the output of the function of the machine learning model (278).

One or more initial values are set for the parameter (280). The machine learning model (278) is then executed on the training data (276). The result is a output (282), which is a prediction, a classification, a value, or some other output which the machine learning model (278) has been programmed to output.

The output (282) is provided to a convergence process (284). The convergence process (284) compares the output (282) to a known result (286). A determination is made whether the output (282) matches the known result (286) to a pre-determined degree. The pre-determined degree may be an exact match, a match to within a pre-specified percentage, or some other metric for evaluating how closely the output (282) matches the known result (286). Convergence occurs when the known result (286) matches the output (282) to within the pre-determined degree.

If convergence has not occurred (a “no” at the convergence process (284)), then a loss function (288) is generated. The loss function (288) is a program which adjusts the parameter (280) in order to generate an updated parameter (290). The basis for performing the adjustment is defined by the program that makes up the loss function (288), but may be a scheme which attempts to guess how the parameter (280) may be changed so that the next execution of the machine learning model (278) using the training data (276) with the updated parameter (290) will have an output (282) that more closely matches the known result (286).

In any case, the loss function (288) is used to specify the updated parameter (290). As indicated, the machine learning model (278) is executed again on the training data (276), this time with the updated parameter (290). The process of execution of the machine learning model (278), execution of the convergence process (284), and the execution of the loss function (288) continues to iterate until convergence.

Upon convergence (a “yes” result at the convergence process (284)), the machine learning model (278) is deemed to be a trained machine learning model (292). The trained machine learning model (292) has a final parameter, represented by the trained parameter (294).

During deployment, the trained machine learning model (292) with the trained parameter (294) is executed again, but this time on the new data for which the final result is not known. The output of the trained machine learning model (292) is then treated as a prediction of the information of interest relative to the unknown data.

While FIG. 2.1 and FIG. 2.2 show a configuration of components, other configurations may be used without departing from the scope of the one or more embodiments. For example, various components may be combined to create a single component. As another example, the functionality performed by a single component may be performed by two or more components.

Attention is now turned to FIG. 3, which shows a flowchart of a method. The method of FIG. 3. may be used to improve a computer by increasing the computational efficiency of generating a simulated prediction of how an oil and gas field may produce oil and gas in response to waterflood injection of fluids. The method of FIG. 3 may also be extended to be a method of controlling an injector in the oil and gas field. The method of FIG. 3 may be executed using the system shown in FIG. 1.

Block 300 includes receiving injector-producer pair parameters for injectors and producers in a target underground region, the plurality of injectors and the plurality of producers arranged in injector-producer pairs. Receiving the injector-producer pair parameters may include receiving outputs from one or more machine learning models. The outputs of the machine learning models may include at least one of the injector-producer pair parameters.

In an embodiment, a pre-processing block performed before block 300 may be added to the method of FIG. 3. For example, the preprocessing block may include executing the one or more machine learning models. In this case, inputs to the machine learning models may be sensed data that are sensed by sensors deployed in the target underground region. However, the inputs to the machine learning models also may be data regarding the target underground region that are stored contained in complex physics-based models.

Outputs of the machine learning models may be at least one of the injector-producer pair parameters. In this case, the receiving operation at block 300 includes receiving the outputs of the machine learning models.

Block 302 includes converting the injector-producer pair parameters into coefficients stored in a data structure. The coefficients represent estimates of connection strengths between injectors and producers of the injector-producer pairs.

The coefficients may be determined from the injector-producer pair parameters. Specifically, converting may include executing an efficiency model. The efficiency model takes as input the injector-producer pair parameters, and generates as output the coefficients. For example, the efficiency model may be an autoregression machine learning model that performs an autoregression procedure on the injector-pair parameters. Once generated, the coefficients are stored in ones of the array of cells. Each coefficient represents a relative efficiency of the corresponding injector-producer pair.

The coefficients are time invariant. Thus, the performance indicators generated in the next block (block 304) are also time invariant. As a result, when the pattern flood management application is executed on the performance indicators at block 308, the pattern flood management application may be executed quickly, relative to the execution times experienced when executing a full, complex physics-based model.

In an embodiment, the coefficients may be weighted to generate a weighted plurality of coefficients stored in the array of cells of the data structure. Weighting biases the coefficients in favor of a first subset of the injector-producer pairs produced by long term models (of the one or more machine learning models), relative to a second subset of the injector-producer pairs produced by short term models (of the one or more machine learning models).

Converting at block 302 may include generating a data structure stored in a non-transitory computer readable storage medium. The data structure includes an array of cells. Each value of the array of cells represents a coefficient of one of the injector-producer pairs.

Block 304 includes generating, from the coefficients, a performance indicator that represents an operational relationship between a corresponding injector and a corresponding producer in an injector-producer pair. Generating the performance indicator may be performed by inputting the coefficients determined at step 302, and possibly other information such as the injector-producer pair parameters, to a set of rules that are executed by a processor. The rule-based determination of the performance indicator is non-iterative, and thus may avoid convergence. Additionally, the rules-based determination is based on time-independent rules that can be executed on user devices available on site at an oil and gas production field. Thus, generation of the performance indicator is computationally efficient.

Generating the performance indicator may include determining, from the coefficients and the injector-producer pair parameters, voidage replacement ratios for the injector-producer pairs. Generating the performance indicator also may include determining, from the coefficients and the injector-producer pair parameters, injection efficiencies for the injector-producer pairs. Generating the performance indicator may include determining, from the voidage replacement ratios and the injection efficiencies, recovery efficiencies for the plurality of injector-producer pairs. Thus, a recovery efficiency may also be the performance indicator.

As indicated with respect to FIG. 2.1, the performance indicator may be multiple performance indicators representing different operational aspects of the injector-producer pair. The performance indicator also may be many different values corresponding to each of the plurality of injector-producer pairs. In other words, there may be multiple performance indicators, and each of the multiple performance indicators may include multiple values.

Block 306 includes transmitting the performance indicator to a pattern flood management application. Transmitting may be performed using a communication device. If the method of FIG. 3 is performed on a single local computer or user device, then transmission may be passing the performance indicator to a pattern flood management application executing on the same single local computer or user device.

Block 308 includes executing the pattern flood management application to output a predicted performance of a producer of the injector-producer pair and simulated injector input parameters of the injector-producer pair. The input to the pattern flood management application may include the performance indicator and also may include other data related to the target underground region.

Examples of other data related to the target underground region may include active connection statuses between injectors-producers, active connection statuses between aquifer-producers and expansion sources to producers, as well as, other connections between sources of fluid and sinks in the target underground region. The other related data may include measures of the flow capacity of the connections and storage capacity of the volumes associated with the connections.

Block 310 includes controlling at least one of a producer and an injector of the injector-producer pair according to the selected simulated injector input parameters. In particular, the simulated injector input parameters may be provided to one or more control mechanisms that is connected to or a part of oil and gas production equipment in either the producer or in the injector, or both. Thus, thee one or more control mechanisms may be attached to injectors, producers, or both. The one or more control mechanisms are controlled according to the simulated injector input parameters.

For example, a valve, pump, or other equipment may be controlled to determine the pressure, flow rate, or other parameters of a liquid pumped into each of several different injectors. In another example, the salinity of the injected liquid may be controlled by using a valve to control from which water source the fluid is pumped. Many other controls (e.g., equipment and control factors (e.g., pressure, flow rate, etc.) are contemplated.

While the various steps in flowchart of FIG. 3 are presented and described sequentially, at least some of the steps may be executed in different orders, may be combined or omitted, and at least some of the steps may be executed in parallel. Furthermore, the steps may be performed actively or passively.

The following example, shown in FIG. 4.1 through FIG. 4.5, is for explanatory purposes and not intended to limit the scope of the one or more embodiments. The example of FIG. 4.1 through FIG. 4.5 may be performed using the systems shown in FIG. 2.1 and FIG. 2.2, using the method described with respect to FIG. 3.

FIG. 4.1 shows an example of an oil and gas field, including target underground region (400). The target underground region (400) includes a number of injectors, including injector 1 (402) and injector 2 (404). The target underground region (400) also includes a number of producers, including producer 1 (408), producer 2 (410), and producer 3 (412). The injectors and the producers may be arranged in pairs. For example, the injector 1 (402) and the producer 1 (408) may be arranged as a pair via an underground connection (414). Similarly, the injector 2 (404) and the producer 3 (412) form a pair via underground connection (416). Ultimately, each of the injectors is paired with each of the producers via the connections shown (resulting in six total pairs of injectors and producers). Note, however, that in a real oilfield, more or fewer injectors and producers may be present, and it may be the case that some of the injectors are not paired with producers.

FIG. 4.2 shows a high-level view of some components of a system of the present disclosure and relationships between these components. The system shown in FIG. 4.2 may include a number of waterflood performance prediction models (418). The waterflood performance prediction models (418) are complex physics-based models that are computationally expensive to execute when performing simulations of the target underground region (400) shown in FIG. 4.1.

The system shown in FIG. 4.2 also includes a pre-processor (420). The pre-processor (420) may be the data structure generator (228) and the performance indicator generator (230) described with respect to FIG. 2.1. The pre-processor (420) may execute the method of FIG. 3, taking, as input, data in the waterflood performance prediction models (418) and generating, as output, the performance indicators that are passed to the pattern flood management application (422).

The pre-processor (420) that connects the waterflood performance prediction models (418) to the pattern flood management application (422) can therefore take input from numerical reservoir simulations and streamline computations or streamline simulations. The waterflood performance prediction models then may provide both data-driven (complex physics-based models) and model-driven methods (which do not directly model the physics of the target underground region (400)) for operations. The waterflood performance prediction models also may provide for tactical and strategic waterflood performance optimization.

The waterflood performance prediction models (418) may remain available for long term strategic management. If these models are regularly updated, then pair measure derived from the different methods described herein can be compared by the user, adjusted, and fed into the pattern flood management application (422). This approach could mitigate risks if either model have any form of bias.

The pattern flood management application (422) then may be executed on the output produced by the pre-processor (420). Because the output of the pre-processor (420) is time-invariant, the pattern flood management application (422) may be executed quickly and efficiently. The output of the pattern flood management application (422) is an optimization strategy (424) (e.g., the simulated injector input parameters (218) described with respect to FIG. 2.1).

The optimization strategy (424) is provided to one or more web application operations dashboards (426). The web application operations dashboards (426) are graphical user interfaces which show the results of the optimization strategy (424) to a user. The web application operations dashboards (426) also may display more computationally expensive forecasts (428) generated by the waterflood performance prediction models (418).

Stated differently, FIG. 4.2 shows an example of design of components of the embodiments and their relationships. The interactive dashboard developed as a web application and executed on the cloud may provide the user with a visual display of the performance of wells. The web application operations dashboards (426) may offer choices to the user to evaluate and recommend corrective actions.

The main optimizer component (the pattern flood management application (422)) receives the unoptimized or current state, applies the chosen strategy, and generates new optimal operational settings for field control mechanisms. If desired, waterflood performance prediction models (418) then may simulate these settings to create forecasts made available to the dashboard component for processing using decision analysis techniques.

The technology may thus use a combination of signal processing techniques to pre-condition a injector-producer relationship matrix, and then may use machine learning regression techniques to train, test, and validate the model using observed production data. The signal processing techniques may include statistical correlation techniques (Pearson with lag), amplitude analysis, pulse analysis, and deconvolution techniques.

Using observed production data may be useful, because the minimum time-series data used may be well liquid production rate, water cut, injection rate, bottom hole flowing pressure. Additional data, such as produced and injected tracer concentrations and fluid temperatures, allows a correlation between injectors and producers.

FIG. 4.3 shows a high-level waterflood analysis and enhancement framework (430). The waterflood analysis and enhancement framework (430) may be implemented by the systems shown in FIG. 2.1 and FIG. 4.2. The waterflood analysis and enhancement framework (430) shows the operations and tactical problems encountered while managing waterfloods.

In particular, FIG. 4.3 shows the flow from the bottom upwards that converts data to decisions. The operational decision model layer (432) may represent the pre-processor (420) of FIG. 4.2 or the system of FIG. 2.1. The operational decision model layer (432) also may include the complex physics-based models. The operational decision model layer (432) may be extensible and can incorporate multi-fidelity models from analytical waterflood performance prediction models to machine models to rigorous physics-based numerical reservoir simulation. Adaptors, such as application programming interfaces, can be written to plug the analyzer into various models of the target underground region.

FIG. 4.4 shows an example of a workflow highlighting the application of the method of FIG. 3 using the system of FIG. 2.1 or using the system of FIG. 4.2. FIG. 4.4 refers to a “hybrid model.” The hybrid model is the time-invariant performance indicators generated together with other data that are input to the pattern flood management application, as described with respect to FIG. 3 and FIG. 4.2. The method of FIG. 4.4 may be executed using a processor, such as the processor (226) of FIG. 2.1.

Block 450 includes loading well data. The well data may be loaded from a data repository and may include data from complex physics-based models, sensed data, and other types of data.

Block 452 includes calibrating the hybrid model. Calibrating the hybrid model includes preparing and executing the machine learning models used to pre-process the data to generate the injector-producer pairs, as described with respect to block 300 of FIG. 3.

Block 454 includes estimating model parameters (e.g., for the hybrid model). The estimation of the model parameters may include generating the matrix of coefficients at block 302 of FIG. 3, generating the performance indicator generated at block 304 of FIG. 3, and adding any other data that desirably may be passed to the pattern flood management application. The data structure that holds the combination of the information is the hybrid model.

Block 456 includes executing baseline forecasts. The baseline forecasts may be executed by executing the pattern flood management application, as described with respect to step 308 of FIG. 3. The baseline forecasts may include the predicted performance (220) of the injectors and the simulated injector input parameters (218), as described with respect to FIG. 2.1.

Block 458 include generating insights. The insights may include not only the baseline forecasts at block 456, but also updated relevant oilfield information. Relevant oilfield information may include, for example, a projection regarding how long the oilfield is likely to continue producing. The insights also may include information such as suggested settings for control mechanisms connected to oilfield production equipment.

In an embodiment, the method of FIG. 4.4 may include updating data at block 460. The data may be received as new sensed data, or may be retrieved or pushed from updated complex physics models.

Receiving the updated data at block 460 may trigger a model update at block 462. As a result, blocks 452, 454, and 456 may be repeated, leading to new generated insights at block 458.

Block 464 includes determining whether the generated insights are acceptable. For example, an oilfield engineer may determine that other “what-if” scenarios should be performed prior to accepting and physically implementing the current baseline forecasts at block 456. In another example, the oilfield engineer may determine that projections relating to injection parameters or production amounts are not acceptable. In still another example, the generated insights may fail to satisfy a threshold. If the threshold fails to be satisfied, block 464 may be performed automatically. In this case, the method of FIG. 4.4 may iterate between blocks 450 to 464, until the generated insights satisfy the threshold (or until some maximum number of iterations reached).

In any case, if the generated insights are not acceptable (a “no” determination at block 464), then the method returns to block 452 and repeats. Otherwise, if the generated insights are acceptable (a “yes” determination at block 464), then the method proceeds at block 466.

Block 466 includes executing an optimization. Executing the optimization includes setting the control mechanisms of injectors to correspond to the injection parameters established in the baseline forecasts at block 456 or the generated insights at block 458. Executing the optimization may include other actions, such as digging new wells, plugging existing wells, or taking some other physical action with respect to the oilfield.

Block 468 includes reviewing the current results. Reviewing may include checking to see whether the physical result of executing the optimization at block 466 resulted in the predicted production values, or resulted in the at least desired production values. Reviewing also may include updating the data (at block 460) using the new injection and production measurements after having executed the optimization at block 466. In this case, the method of FIG. 4.4 may repeat.

Block 470 includes determining whether the review at block 468 is deemed acceptable. The review may be acceptable if a user determines that the review is acceptable. The review also may be acceptable if an automated process compares the measured injection and production values that resulted from executing the optimization at block 466, and comparing the values to one or more thresholds.

If the thresholds are not satisfied (or a user determines that the review is not acceptable), then the method returns to block 466 (a “no” determination at block 470). Otherwise, if the threshold are satisfied (or a user determines that the review is acceptable), then in one embodiment, the method of FIG. 4.4 may terminate thereafter.

FIG. 4.5 shows an example of a data structure, such as the data structure (204) described with respect to FIG. 2.1 and generated according to the method described with respect to block 302 of FIG. 3. The data structure (480) may be a table. The columns of the table are producers. The rows of the table are injectors. Each cell in the array of the table includes the coefficient for a given injector and a given producer. Thus, for three injectors and four producers there may be twelve coefficients generated.

Again, the coefficients (208) are numbers (i.e. values stored in the array of cells (206) of FIG. 2.1) that represent estimates of physical connection strengths between injectors and producers of the injector-producer pairs. In other words, the coefficients represent how strongly a change in fluid injector parameters at an injector influences production at the multiple producers.

In summary, the reservoir surveillance engineer may pull production and injection data from an online database. The engineer then may, with well completion location information, proceed to build and calibrate the machine learning-assisted assisted hybrid model described above. Once the hybrid model is calibrated, the hybrid model is ready for use in the analysis and enhancement workflow.

Several conditions can trigger an update of the model to be accurate for analysis and enhancement. The surveillance engineer uses the dashboards to monitor the performance of the field and wells, as well as, to find set points to analyze and enhance performance or recommend remedial operations. Thus, a computationally efficient method for generating simulated injector input parameters and a predicted performance of producers is presented. The computationally efficient method permits real time simulations to be performed, and thus permits real time adjustments to oil and gas equipment control mechanisms to maximize the efficiency and production of waterflooding operations.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, In some embodiments, the methods of the present disclosure may be executed by a computing system. FIG. 5 illustrates an example of such a computing system 500, in accordance with some embodiments. The computing system 500 may include a computer or computer system 501A, which may be an individual computer system 501A or an arrangement of distributed computer systems. The computer system 501A includes one or more analysis modules 502 that are configured to perform various tasks according to some embodiments, such as one or more methods disclosed herein. To perform these various tasks, the analysis module 502 executes independently, or in coordination with, one or more processors 504, which is (or are) connected to one or more storage media 506. The processor(s) 504 is (or are) also connected to a network interface 507 to allow the computer system 501A to communicate over a data network 509 with one or more additional computer systems and/or computing systems, such as 501B, 501C, and/or 501D (note that computer systems 501B, 501C and/or 501D may or may not share the same architecture as computer system 501A, and may be located in different physical locations, e.g., computer systems 501A and 501B may be located in a processing facility, while in communication with one or more computer systems such as 501C and/or 501D that are located in one or more data centers, and/or located in varying countries on different continents).

A processor may include a microprocessor, microcontroller, processor module or subsystem, programmable integrated circuit, programmable gate array, or another control or computing device.

The storage media 506 may be implemented as one or more computer-readable or machine-readable storage media. Note that while in the example embodiment of FIG. 5 storage media 506 is depicted as within computer system 501A, in some embodiments, storage media 506 may be distributed within and/or across multiple internal and/or external enclosures of computing system 501A and/or additional computing systems. Storage media 506 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 500 contains one or more hybrid model module(s) 508. In the example of computing system 500, computer system 501A includes the hybrid model module 508. In some embodiments, a single hybrid model module may be used to perform some aspects of one or more embodiments of the methods disclosed herein. In other embodiments, a plurality of hybrid model modules may be used to perform some aspects of methods herein.

It should be appreciated that computing system 500 is merely one example of a computing system, and that computing system 500 may have more or fewer components than shown, may combine additional components not depicted in the example embodiment of FIG. 5, and/or computing system 500 may have a different configuration or arrangement of the components depicted in FIG. 5. The various components shown in FIG. 5 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 500, FIG. 5), and/or through manual control by a user who may make determinations regarding whether a given step, action, template, model, or set of curves has become sufficiently accurate for the evaluation of the subsurface three-dimensional geologic formation under consideration.

As used herein, connected to contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the word “or” is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited by the attached claims.

What is claimed is:

1. A method comprising:
receiving a plurality of injector-producer pair parameters for a plurality of injectors and a plurality of producers in a target underground region, the plurality of injectors and the plurality of producers including a plurality of injector-producer pairs;
converting the plurality of injector-producer pair parameters into a plurality of coefficients stored in a data structure, wherein the plurality of coefficients represent estimates of connection strengths between injectors and producers of the plurality of injector-producer pairs;
generating, from the plurality of coefficients, a performance indicator that represents an operational relationship between a corresponding injector and a corresponding producer in an injector-producer pair of the plurality of injector-producer pairs; and
transmitting the performance indicator to a pattern flood management application.

2. The method of claim 1, comprising:
executing the pattern flood management application, wherein:
an input of the pattern flood management application includes the performance indicator, and
an output of the pattern flood management application includes:
a predicted performance of a producer of an injector-producer pair of the plurality of injector-produce pairs, and
selected simulated injector input parameters for an injector of the injector-producer pair.

3. The method of claim 2, comprising:
controlling at least one of a producer and an injector of the injector-producer pair according to the selected simulated injector input parameters.

4. The method of claim 1, wherein the performance indicator includes a plurality of performance indicators representing different operational aspects of an injector-producer pair of the plurality of injector-produce pairs.

5. The method of claim 1, wherein the performance indicator is selected from the group consisting of:
an injection efficiency of an injector of an injector-producer pair of the plurality of injector-produce pairs;
a recovery efficiency of a producer of the injector-producer pair; and
a voidage replacement ratio of the injector-producer pair.

6. The method of claim 1, wherein the performance indicator includes a plurality of different values corresponding to each of the plurality of injector-producer pairs.

7. The method of claim 1, wherein generating the performance indicator includes:
determining, from the plurality of coefficients and the plurality of injector-producer pair parameters, voidage replacement ratios for the plurality of injector-producer pairs;
determining, from the plurality of coefficients and the plurality of injector-producer pair parameters, injection efficiencies for the plurality of injector-producer pairs; and
determining, from the voidage replacement ratios and the injection efficiencies, recovery efficiencies for the plurality of injector-producer pairs,
wherein the at least one of the recovery efficiencies includes the performance indicator.

8. The method of claim 1, wherein receiving includes:
receiving outputs from a plurality of machine learning models, wherein the outputs include at least one of the plurality of injector-producer pair parameters.

9. The method of claim 1, comprising:
executing a plurality of machine learning models, wherein inputs to the plurality of machine learning models include sensed data that are sensed by sensors deployed in the target underground region, and wherein outputs of the plurality of machine learning models include at least one of the plurality of injector-producer pair parameters; and
wherein receiving includes receiving the outputs of the plurality of machine learning models.

10. The method of claim 9, wherein the plurality of machine learning models includes physics-based machine learning models.

11. The method of claim 1, wherein receiving includes receiving outputs from a plurality of machine learning models, wherein the outputs include at least one of the plurality of injector-producer pair parameters, and wherein converting includes:
generating the data structure stored in a non-transitory computer readable storage medium, wherein:
the data structure includes an array of cells, and
each value of the array of cells represents a coefficient of one of the plurality of injector-producer pairs;
executing an efficiency model, wherein the efficiency model takes as input the plurality of injector-producer pair parameters, and generates as output the plurality of coefficients;
weighting the plurality of coefficients to generate a weighted plurality of coefficients,
wherein weighting biases the plurality of coefficients in favor of a first subset of the plurality of injector-producer pairs produced by long term models of the plurality of machine learning models, relative to a second subset of the plurality of injector-producer pairs produced by short term models of the plurality of machine learning models; and
storing the weighted plurality of coefficients in ones of the array of cells.

12. The method of claim 1, wherein converting includes:
generating the data structure stored in a non-transitory computer readable storage medium, wherein:
the data structure includes an array of cells, and
each value of the array of cells represents a coefficient of one of the plurality of injector-producer pairs;
executing an efficiency model, wherein the efficiency model takes as input the plurality of injector-producer pair parameters, and generates as output the plurality of coefficients; and
storing the plurality of coefficients in ones of the array of cells.

13. The method of claim 12 wherein the efficiency model includes an autoregression machine learning model.

14. A system comprising:
a processor;
a data repository in communication with the processor, the data repository storing:
a plurality of injector-producer pair parameters for a plurality of injectors and a plurality of producers in a target underground region, wherein the plurality of injectors and the plurality of producers include a plurality of injector-producer pairs,
a plurality of coefficients representing estimates of connection strengths between injectors and producers of the plurality of injector-producer pairs, and
a data structure configured to store the plurality of coefficients, and
a performance indicator that represents an operational relationship between a corresponding injector and a corresponding producer in an injector-producer pair of the plurality of injector-producer pairs;
a data structure generator which, when executed by the processor, performs operations including:
generating the data structure,
converting the plurality of injector-producer pair parameters into the plurality of coefficients, and
storing the plurality of coefficients in the data structure;
a performance indicator generator which, when executed by the processor, generates the performance indicator from the plurality of coefficients; and
a communication device for:
receiving the injector-producer pair parameters, and
transmitting the performance indicator to a pattern flood management application.

15. The system of claim 14, comprising:
the pattern flood management application, wherein:
an input of the pattern flood management application includes the performance indicator, and
an output of the pattern flood management application includes:
a predicted performance of a producer of an injector-producer pair of the plurality of injector-produce pairs, and
selected simulated injector input parameters for an injector of the injector-producer pair.

16. The system of claim 15, comprising:
an injector of the injector-producer pair; and
a control mechanism for controlling at least one of the producer and the injector according to the selected simulated injector input parameters.

17. The system of claim 15, wherein the performance indicator generator, when executed by the processor, generates the performance indicator from the plurality of coefficients by performing operations including:
determining, from the plurality of coefficients and the plurality of injector-producer pair parameters, voidage replacement ratios for the plurality of injector-producer pairs;
determining, from the plurality of coefficients and the plurality of injector-producer pair parameters, injection efficiencies for the plurality of injector-producer pairs; and
determining, from the voidage replacement ratios and the injection efficiencies, recovery efficiencies for the plurality of injector-producer pairs,
wherein the at least one of the recovery efficiencies includes the performance indicator.

18. The system of claim 15, comprising:
a plurality of machine learning models executable by the processor, wherein inputs to the plurality of machine learning models include data sensed by sensors deployed in the target underground region, and wherein outputs of the plurality of machine learning models include at least one of the plurality of injector-producer pair parameters; and
wherein the communication device receives the injector-producer pair parameters as the outputs of the plurality of machine learning models.

19. The system of claim 15, wherein the data structure generator:
generates the data structure as an array of cells, wherein each value of the array of cells represents a coefficient of one of the plurality of injector-producer pairs;
converts the plurality of injector-producer pair parameters into the plurality of coefficients by executing an efficiency model, wherein the efficiency model takes, as input, the plurality of injector-producer pair parameters, and generates, as output, the plurality of coefficients; and
storing the plurality of coefficients in ones of the array of cells.

20. A non-transitory computer readable storage medium storing program code which, when executed by a processor, performs a computer-implemented algorithm comprising:
receiving a plurality of injector-producer pair parameters for a plurality of injectors and a plurality of producers in a target underground region, the plurality of injectors and the plurality of producers including a plurality of injector-producer pairs;
converting the plurality of injector-producer pair parameters into a plurality of coefficients stored in a data structure, wherein the plurality of coefficients represent estimates of connection strengths between injectors and producers of the plurality of injector-producer pairs;
generating, from the plurality of coefficients, a performance indicator that represents an operational relationship between a corresponding injector and a corresponding producer in an injector-producer pair of the plurality of injector-producer pairs; and
transmitting the performance indicator to a pattern flood management application.
